(19) United States
(12) Patent Application Publication
(10) Pub. No.: US 2020/0270936 A1
(43) Pub. Date: Aug. 27, 2020

(54) Window Safety Plate

(71) Applicant: Lance Edward Sargent, Butler, MO (US)

(72) Inventor: Lance Edward Sargent, Butler, MO (US)

(21) Appl. No.: 16/802,285

(22) Filed: Feb. 26, 2020

Related U.S. Application Data
(60) Provisional application No. 62/810,719, filed on Feb. 26, 2019.

(51) Int. Cl. E06B 5/10; E05B 65/08; E05D 15/06

(52) U.S. Cl. CPC E06B 5/10; E06B 5/106; E05D 15/0621; E05B 65/08

(57) ABSTRACT

A window safety plate includes a window-mounted frame, a bullet resistant plate, and a locking mechanism. The window mounted frame includes an upper track, a lower track, a first stopper, and a second stopper. The upper track and the lower track are terminally connected to the first stopper. The upper track and the lower track are terminally connected to the second stopper, opposite of the first stopper. The bullet resistant plate is slidably engaged within the upper track, the lower track, the first stopper, and the second stopper so that a window section of a door can be concealed from inside of a room. The locking mechanism is integrated in between the window-mounted frame and the bullet resistant plate thus enabling an intruder to slide back the bullet resistant plate from outside of the room.

The current application claims a priority to the U.S. Provisional Patent application Ser. No. 62/810,719 filed on Feb. 26, 2019.

### FIELD OF THE INVENTION

The present invention relates generally to cover. More specifically, the present invention is a window cover to obstruct a shooter's vision during active shooter incidents.

### BACKGROUND OF THE INVENTION

With active shooter incidents becoming more and more prevalent, countermeasures such as safety drills, metal detectors, and other similar apparatus or methods have been taken to prevent or minimize casualties. However, windows of a building provide an easy access points to a shooter who is trying the forcefully enter into a building. Since the windows can be easily broken with any rigid and heavy objects, there is a demand to improve the safety aspect of an existing window without completely replacing them with new and improved windows.

It is an object of the present invention to cover existing windows of any kind during an active shooter incident to obstruct the shooter's vision and keep the shooter from shooting freely. More specifically, a safety plate of the present invention can be easily slid along a pair of tracks of the present invention to cover an existing window. Furthermore, the safety plate can be locked within the pair of tracks so that a shooter is not able to slide back the safety plate. As a result, the present invention is able to delay an entering process of a shooter thus providing additional time for victims to get to safety and law enforcement officers to reach the active shooter incidents.

### BRIEF DESCRIPTION OF THE DRAWINGS

FIG. 1 is a perspective view of the present invention installed within a window of a door, wherein the bullet resistant plate is not covering the window.

FIG. 2 is a perspective view of the present invention installed within a window of a door, wherein the bullet resistant plate is covering the window.

FIG. 3 is a perspective exploded view of the present invention along with a door.

FIG. 4 is a front view of the present invention, showing the plane upon which a cross sectional view is taken shown in FIG. 5.

FIG. 5 is a cross section view of the present invention taken along line 5-5 of FIG. 4 and showing detailed view sections are taken shown in FIG. 6 and FIG. 7.

FIG. 6 is a detailed view for the upper opening and upper locking body of the present invention taken within section line 6.

FIG. 7 is a detailed view for the lower opening and lower locking body of the present invention taken within section line 7.

### DETAIL DESCRIPTIONS OF THE INVENTION

All illustrations of the drawings are for the purpose of describing selected versions of the present invention and are not intended to limit the scope of the present invention.

The present invention is a window safety plate that slides along an existing window of an entry door. The present invention is able to obstruct a shooter's vision into a room through the existing window of the entry door during an active shooter incident. Furthermore, the present invention can be locked in a stationary position so that a shooter is not able to slide back the present invention about the existing window of the entry door. As a result, the present invention is able to delay an entering process of a shooter thus providing additional time for victims to get to safety and law enforcement officers to reach the active shooter incidents.

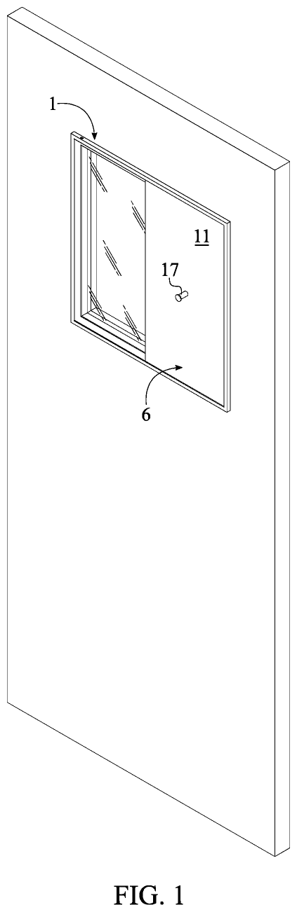

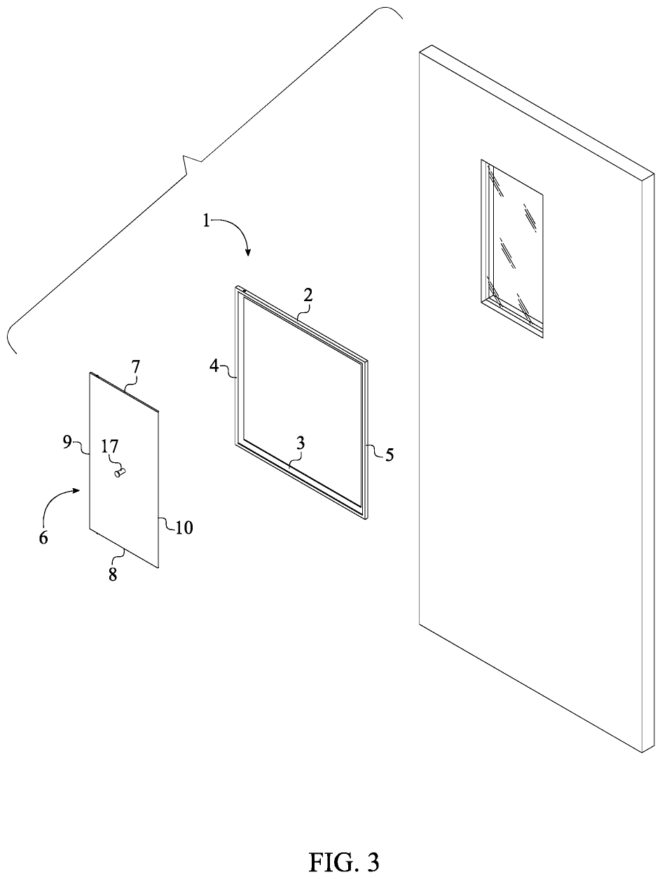

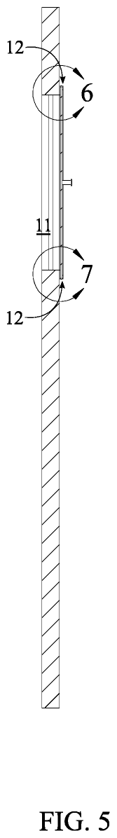

The present invention comprises a window-mounted frame 1, a bullet resistant plate 6, and a locking mechanism 12 as shown in FIG. 1-2 and FIG. 5. The window-mounted frame 1 comprises an upper track 2, a lower track 3, a first stopper 4, and a second stopper 5 as shown in FIG. 3. In reference to a general configuration of the present invention, the upper track 2 and the lower track 3 are terminally connected to the first stopper 4. The upper track 2 and the lower track 3 are terminally connected to the second stopper 5 and position opposite of the first stopper 4. In other words, the upper track 2, the lower track 3, the first stopper 4, and the second stopper 5 delineate a rectangular shape for the window-mounted frame 1. The bullet resistant plate 6 is slidably engaged within the upper track 2, the lower track 3, the first stopper 4, and the second stopper 5 so that the existing window of the entry door can be concealed. For example, the bullet resistant plate 6 slides in between an opened position and a closed position thus opening or closing the existing window of the entry door. The locking mechanism 12 is integrated in between the window-mounted frame 1 and the bullet resistant plate 6 so that the bullet resistant plate 6 cannot slide back to access the existing window of the entry door.

The window-mounted frame 1 is designed to be secured an inside surface of the entry door. More specifically, the window-mounted frame 1 is mounted to the entry door through a plurality of screws or any other type of fasteners. Furthermore, the window-mounted frame 1 can also be premanufactured into the entry door. In reference to FIG. 3, the upper track 2 and the lower track 3 are positioned parallel to each other and extended across the entry door. As a result, the upper track 2 and the lower track 3 function as the supporting structure that allows the bullet resistant plate 6 to slide back and forth. The first stopper 4 and the second stopper 5 are positioned parallel to each other and extended along the entry door. The upper track 2 and the lower track 3 are positioned perpendicular to the first stopper 4 and the second stopper 5 so that the rectangular shape of the window-mounted frame 1 can be delineated. Furthermore, the first stopper 4 and the second stopper 5 function as endcap barriers for the bullet resistant plate 6 thus retaining the bullet resistant plate 6.

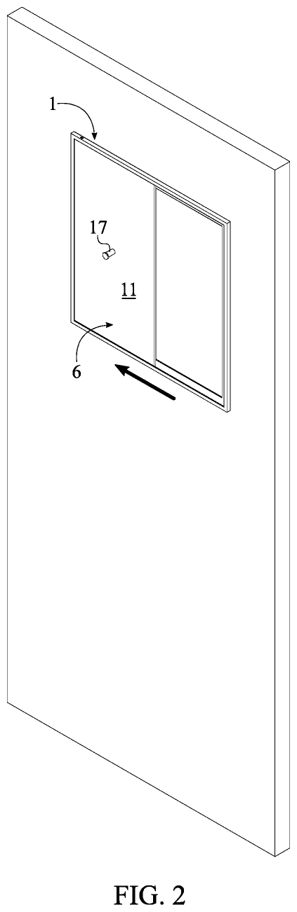

The bullet resistant plate 6 is preferably made of 316 steel plates; however, the bullet resistant plate 6 can also be made from any other types of strong materials such as ceramic material, composite materials, and any other types steel materials. In reference to FIG. 3, the bullet resistant plate 6 comprises a top edge 7, a bottom edge 8, a first edge 9, and a second edge 10. More specifically, the top edge 7 is slidably positioned within the upper track 2, and the bottom edge 8 is slidably positioned within the lower track 3 so that the bullet resistant plate 6 can travel along the upper track 2 and the lower track 3. The first edge 9 is oriented towards the first stopper 4 so that the sliding movement of the bullet resistant plate 6 can come to an end when the first edge 9 is pressed against the first stopper 4. The second edge 10 is oriented towards the second stopper 5 so that the sliding movement of the bullet resistant plate 6 can come to an end when the second edge 10 is pressed against the second stopper 5. As shown in FIG. 1 and FIG. 3, the bullet resistant plate 6 is at the opened position as the existing window of the entry door is visible through the window-mounted frame 1. As shown in FIG. 2 and FIG. 3, the bullet resistant plate 6 is at the closed position as the existing window of the entry door is hidden with the window-mounted frame 1.

Optionally, the present invention can comprise a plurality of upper rollers and a plurality of lower rollers. The plurality of upper rollers can be positioned in between the top edge 7 and the upper track 2 to minimize the friction and to provide a smooth sliding movement for the bullet resistant plate 6 about the top edge 7. The plurality of lower rollers can be positioned in between the bottom edge 8 and the lower track 3 to minimize the friction and to provide a smooth sliding movement for the bullet resistant plate 6 about the bottom edge 8.

Furthermore, the present invention can comprise an upper bracket and a lower bracket. The upper bracket encloses the top edge 7, and the lower bracket encloses the bottom edge 8. The upper bracket and the lower bracket provide a smooth sliding movement for the bullet resistant plate 6 about the top edge 7 and the bottom edge 8 respectively. Preferably, the upper bracket and the lower bracket are U-shaped plastic brackets that can completely covers the top edge 7 and the bottom edge 8.

As a result, the bullet resistant plate 6 can be easily operated by a responsible adult to a child as minimum about of force is required to slide the bullet resistant plate 6 along the upper track 2 and the lower track 3.

The present invention further comprises a handle 17 as shown in FIG. 3. The handle 17 is laterally connected onto a front surface 11 of the bullet resistant plate 6 so that the handle 17 can only be accessed by an individual inside the room. The handle 17 provides sufficient surface area to grasp and move the bullet resistant plate 6.

The present invention further comprises a sticker that can be adhered onto the front surface 11. More specifically, the printed material of the sticker can include, but is not limited to, educational information, safety regulations, general institutional information, and decorative information. Additionally, the sticker is also able to provide an aesthetically pleasing appearance for the present invention.

Furthermore, the locking mechanism 12 prevents an active shooter from reaching through the existing window of the entry door once it is broken. As a result, an active shooter is not able to unlock the entry door handle from inside to enter into the room. The locking mechanism 12 also prevents an active shooter from breaking the existing window of the entry door and sticking a gun through the existing window to shoot victims.

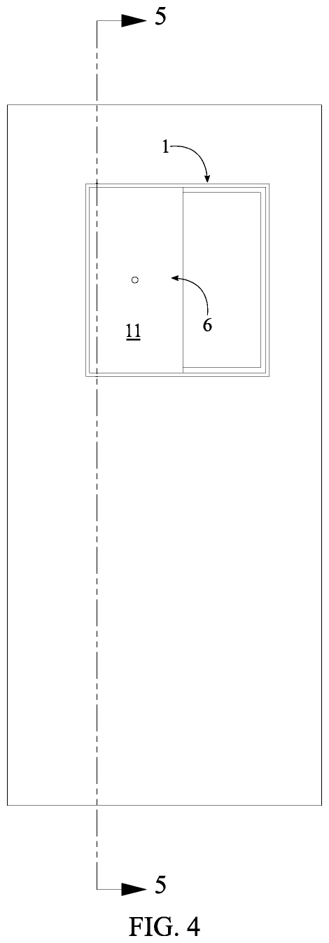

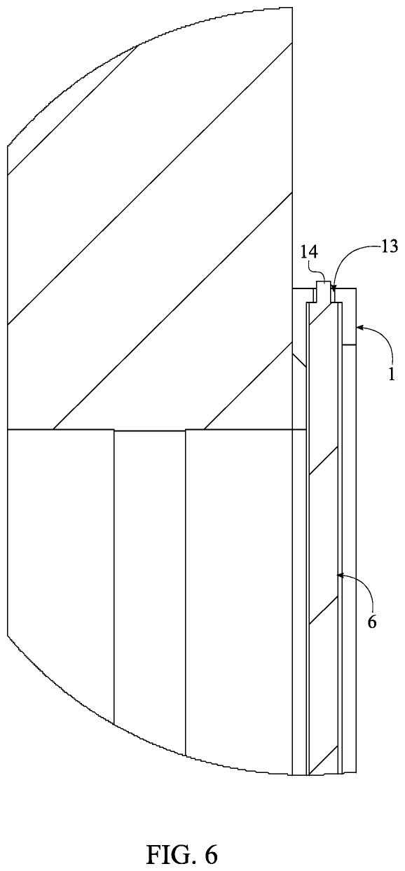

The locking mechanism 12 comprises an upper opening 13 and an upper locking body 14 as shown in FIG. 4-6. More specifically, the upper opening 13 traverses through the upper track 2. The upper locking body 14 is mounted to the bullet resistant plate 6, wherein the upper locking body 14 can be a quick release pin, a spring loaded body, or any other types of quick engaging body. The upper opening 13 and the upper locking body 14 are selectively engaged with each other about the top edge 7 in order to stop a shooter from sliding back the bullet resistant plate 6 away from the existing window of the entry door.

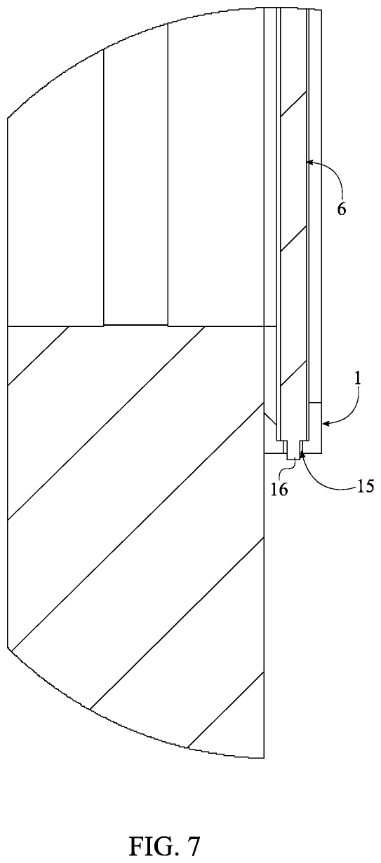

The locking mechanism 12 further comprises a lower opening 15 and a lower locking body 16 as shown in FIG. 4-5 and FIG. 7. More specifically, the lower opening 15 traverses through the lower track 3. The lower locking body 16 is mounted to the bullet resistant plate 6, wherein the lower locking body 16 can be a quick release pin, a spring loaded body, or any other types of quick engaging body. The lower opening 15 and the lower locking body 16 are selectively engaged with each other about the bottom edge 8 in order to stop a shooter from sliding back the bullet resistant plate 6 away from the existing window of the entry door.

In some embodiment of the present invention, only the upper locking body 14 and the upper opening 13 are utilized to lock the bullet resistant plate 6. In some embodiment, only the lower locking body 16 and the lower opening 15 are utilized to lock the bullet resistant plate 6. In some embodiment, the upper locking body 14 and the lower locking body 16 are respectively utilized with the upper opening 13 and the lower opening 15 to secure the bullet resistant plate 6 in place.

Although the invention has been explained in relation to its preferred embodiment, it is to be understood that many other possible modifications and variations can be made without departing from the spirit and scope of the invention as hereinafter claimed.

What is claimed is:

1. A window safety plate comprising:
a window-mounted frame;
a bullet resistant plate;
a locking mechanism;
the window-mounted frame comprising an upper track, a lower track, a first stopper, and a second stopper;
the upper track and the lower track being terminally connected to the first stopper;
the upper track and the lower track being terminally connected to the second stopper, opposite of the first stopper;
the bullet resistant plate being slidably engaged within the upper track, the lower track, the first stopper, and the second stopper; and
the locking mechanism being integrated in between the window-mounted frame and the bullet resistant plate.

2. The window safety plate as claimed in claim 1 comprising:
the upper track and the lower track being positioned parallel to each other;
the first stopper and the second stopper being positioned parallel to each other; and
the upper track and the lower track being positioned perpendicular to the first stopper and the second stopper.

3. The window safety plate as claimed in claim 1 comprising:
the bullet resistant plate comprising a top edge, a bottom edge, a first edge, and a second edge;
the top edge being slidably positioned within the upper track;
the bottom edge being slidably positioned within the lower track;
the first edge being oriented towards the first stopper; and
the second edge being oriented towards the second stopper.

4. The window safety plate as claimed in claim 1 comprising:
a handle; and
the handle being laterally connected onto a front surface of the bullet resistant plate.

5. The window safety plate as claimed in claim 1 comprising:
the locking mechanism comprising an upper opening and an upper locking body;
the upper opening traversing through the upper track;
the upper locking body being mounted to the bullet resistant plate; and
the upper opening and the upper locking body being selectively engaged with each other.

6. The window safety plate as claimed in claim 1 comprising:
the locking mechanism comprising a lower opening and a lower locking body;
the lower opening traversing through the lower track;
the lower locking body being mounted to the bullet resistant plate; and
the lower opening and the lower locking body being selectively engaged with each other.

7. A window safety plate comprising:
a window-mounted frame;
a bullet resistant plate;
a locking mechanism;
a handle;
the window-mounted frame comprising an upper track, a lower track, a first stopper, and a second stopper;
the upper track and the lower track being terminally connected to the first stopper;
the upper track and the lower track being terminally connected to the second stopper, opposite of the first stopper;
the bullet resistant plate being slidably engaged within the upper track, the lower track, the first stopper, and the second stopper;
the locking mechanism being integrated in between the window-mounted frame and the bullet resistant plate; and
the handle being laterally connected onto a front surface of the bullet resistant plate.

8. The window safety plate as claimed in claim 7 comprising:
the upper track and the lower track being positioned parallel to each other;
the first stopper and the second stopper being positioned parallel to each other; and
the upper track and the lower track being positioned perpendicular to the first stopper and the second stopper.

9. The window safety plate as claimed in claim 7 comprising:
the bullet resistant plate comprising a top edge, a bottom edge, a first edge, and a second edge;
the top edge being slidably positioned within the upper track;
the bottom edge being slidably positioned within the lower track;
the first edge being oriented towards the first stopper; and
the second edge being oriented towards the second stopper.

10. The window safety plate as claimed in claim 7 comprising:
the locking mechanism comprising an upper opening and an upper locking body;
the upper opening traversing through the upper track;
the upper locking body being mounted to the bullet resistant plate; and
the upper opening and the upper locking body being selectively engaged with each other.

11. The window safety plate as claimed in claim 7 comprising:
the locking mechanism comprising a lower opening and a lower locking body;
the lower opening traversing through the lower track;
the lower locking body being mounted to the bullet resistant plate; and
the lower opening and the lower locking body being selectively engaged with each other.

12. A window safety plate comprising:
a window-mounted frame;
a bullet resistant plate;
a locking mechanism;
a handle;
the window-mounted frame comprising an upper track, a lower track, a first stopper, and a second stopper;
the bullet resistant plate comprising a top edge, a bottom edge, a first edge, and a second edge;
the upper track and the lower track being terminally connected to the first stopper;
the upper track and the lower track being terminally connected to the second stopper, opposite of the first stopper;
the bullet resistant plate being slidably engaged within the upper track, the lower track, the first stopper, and the second stopper;
the top edge being slidably positioned within the upper track;
the bottom edge being slidably positioned within the lower track;
the first edge being oriented towards the first stopper;
the second edge being oriented towards the second stopper;
the locking mechanism being integrated in between the window-mounted frame and the bullet resistant plate; and
the handle being laterally connected onto a front surface of the bullet resistant plate.

13. The window safety plate as claimed in claim 12 comprising:
the upper track and the lower track being positioned parallel to each other;
the first stopper and the second stopper being positioned parallel to each other; and
the upper track and the lower track being positioned perpendicular to the first stopper and the second stopper.

14. The window safety plate as claimed in claim 12 comprising:
the locking mechanism comprising an upper opening and an upper locking body;
the upper opening traversing through the upper track;
the upper locking body being mounted to the bullet resistant plate; and
the upper opening and the upper locking body being selectively engaged with each other.

15. The window safety plate as claimed in claim 12 comprising:
the locking mechanism comprising a lower opening and a lower locking body;
the lower opening traversing through the lower track;
the lower locking body being mounted to the bullet resistant plate; and
the lower opening and the lower locking body being selectively engaged with each other.
